(19) United States
(12) Patent Application Publication
(10) Pub. No.: US 2002/0130006 A1
(43) Pub. Date: Sep. 19, 2002

(54) Spindle lock system

(76) Inventors: Daijiro Nakamura, Nishi-Ku (JP); Robert W. Klemm, Colgate, WI (US)

Correspondence Address: MICHAEL BEST & FRIEDRICH, LLP, 100 E WISCONSIN AVENUE, MILWAUKEE, WI, 53202, US

(21) Appl. No.: 09/995,256

(22) Filed: Nov. 27, 2001

(30) Foreign Application Priority Data
Mar. 14, 2001 (JP) TOKUGAN2001-71814
Sep. 12, 2001 (JP) TOKUGAN2001276044

(51) Int. Cl. B25F 5/00; F16D 15/00

(52) U.S. Cl. 192/38; 173/217

(57) ABSTRACT

The present invention is characterized by being a spindle lock system provided with the rotation control device for controlling both of the rotation drive material and the spindle lock material into the determined controlled place by a resilient force between them, wherein the output electric structure is provided in such a way that the rotation drive material and the spindle lock material are connected in order that the rotation force can be conveyed, forming a free angle within which the rotation force will not be conveyed, together with the lock structure capable of releasing the said lock material by means of right and locking rotations of the said rotation drive material after locking the right and locking rotations of the said spindle lock material by pressing the locking material upon the fixing material with the lock operation material and when the drive is stopped, the resilient force of the rotation control device will provided control and buffer effects on the rotation by inertia of the spindle lock material, while there is no impact or clunk caused by the sudden stop, thus providing for a quiet stop.

### DETAILED DESCRIPTION OF THE INVENTION

1. Field of Art Pertaining to the Invention

The present invention relates to a spindle lock system capable of locking the said spindle when, for example, the motor is controlled and stopped and its spindle is stopped in respect of the electric moving instruments like electric drivers.

2. Prior Art

There used to be a rotating instrument disclosed in the Japanese public gazette No.6-53350 (Nippon-koku Toku-Ko-Hei: Patent Publication Number), for instance, provided with the spindle lock system when the motor is controlled and stopped, concerning the above said electric instrument.

However, this instrument of conventional art comprises the protrusion formed on the circumference of the input axis for inputting the driving force and the protrusion formed on the circumference of the spindle for outputting the rotating force, thus forming a given free angle when being connected and between both protrusions inside the said free angle there is formed a pair of the rollers corresponding to the direction of right rotation and the locking direction and a pair of the inclined surfaces of the wedge effects locking by the effects of the wedge in correspondence with the said right and the locking direction, on the side of the spindle, thus forming a locking structure.

According to this conventional structure, the rotating force from the inputting axis would be imparted to the spindle with the driving force against the protrusion of the spindle, the roller and the protrusion on the side of the inputting axis material while releasing the locking structure having been locked, thus imparting the right and locking rotating force to the spindle and when the rotation of the inputting axis material is stopped and the spindle is rotated manually, for instance, for a free angle in the right and locking direction, the above said roller will get stuck on the inclined surface with the wedge effect, corresponding to the rotating direction and have rotation locked by the wedge effect.

Therefore, when the rotation of the inputting axis is stopped, the spindle is put into a position capable of being locked, however, this locking system operates by carrying out the right and locking rotation for a free angle of the spindle and thus, the following problems might occur, accompanied by the rotation for this free angle.

In other words, when tools of high rotating charge on the above said spindle, for example, hole saw and other disc rotating bodies are to be attached and operated through the chuck and the rotating axis is stopped by controlling and stopping the motor and stopping the drive of the inputting axis material as explained above, the tools will continue its rotation with its inertia. Therefore, after the tools are rotated for a free angle, the rotation of the tools will cease with the operation of the lock, however, because the rotation is stopped from the tools by a sudden locking without being controlled, an impact arises both for the locking material (the above said roller) and the adjacent material (the above said protrusion on the side of the inputting axis material or the protrusion on the side of the spindle) charging impact-wise heavily on these materials, causing a big clunk.

Also, with a sudden stopping as described above, the tools will rotate adversely for a free angle while releasing the said lock by reaction and with the wedge effects involving the locking direction, the lock will operate. However, when the inertia occurring in the above said tools is great, both right and locking rotations will take place several times, thus involving the chattering phenomenon repeating the right and locking rotations around the spindle and this happens strongly as the inertia involving the tools is great, thus entailing the problems causing the damages and loss of inner elements of the device, together with the arising chattering phenomenon caused with a big clunk.

Also, according to the above said conventional structure, the rotation force from the inputting axis material would be conveyed through the protrusion on the inputting axis to the protrusion the spindle so that the roller is pushed against the protrusion and with the increasing cohesiveness of the oil in the greases after many years of use, the roller and the protrusion get more liable to be fixed and even without the pressure of the roller, the roller stays attached to the protrusion, preventing the said roller from moving to the position where the locking is to be operated, involving a problem that the locking does not work.

### PROBLEMS TO BE RESOLVED BY THE INVENTION

The object of the present invention is to provide a spindle lock system capable of getting rid of the clunk arising from the rotation by inertia on the outputting side when the drive and the spindle are stopped and reducing the impact charge, while carrying out the locking operation constantly and smoothly, provided with the locking structure.

### MEANS OF SOLVING THE PROBLEMS

The present invention comprises a spindle lock system, in which there is provided an outputting electric structure connecting the rotation drive material for outputting the rotation drive force and the spindle material for outputting the rotation force driven by the said spindle material so that there is formed a free angle preventing the rotation for a determined angle in the mutual directions of rotation on the same spindle in order to convey the rotation, being provided with the said spindle material and the fixing material which fixes the rotation by being placed on the outer part of the said materials with a determined distance in the direction of the radius, wherein, between the said spindle material and the fixing material, there is provided a locking material for locking the right and locking rotation of the said spindle and wherein the said locking material is pressed onto the fixing material, together with the lock operation material for pressing and attaching the said locking material onto the fixing material by the right and locking rotation of the said spindle and with the locking structure formed and provided with the releasing material capable of releasing the locking device of the said locking material having been pressed by the right and locking rotation of the said rotation drive material, containing the rotation controlling structure for controlling both of the said materials with a resilient force in a controlling position, between the said rotation drive and the spindle.

According to the above said construction, when the rotation drive material or the spindle is stopped, this stopping process can be done quietly without producing the impact or clunk accompanied by the sudden stop as the resilient force of the rotation controlling structure is given to the said rotation force with the controlling and buffering effects for the control on to the controlling position even though the said spindle continues its rotation by inertia caused on the said spindle material.

Furthermore, when the inertia caused on the said spindle is larger than the resilient force of the rotation controlling structure and even when the rotation does not stop in the controlling position being controlled, the controlling and buffering effects of the rotation controlling structure with a resilient force is still put on the rotating force moved by inertia, thus controlling the rotation by inertia of the spindle at an early stage, put into the controlling position, without causing chattering and thus providing for a quiet stop.

Furthermore, the present invention comprises a spindle lock system provided with the said output electric structure and the locking structure, wherein the locking material of the said locking structure is attached onto the spindle with a subsequent free angle smaller than the free angle of the said output electric structure and between the said locking operation material and the said spindle there is provided a rotation controlling structure for controlling the said locking material in function of the right and locking rotations in such a middle position as to be able to operate the said locking device, by means of the resilient force.

According to the above construction, when the rotation drive material or a spindle is stopped, the lock operation material operates the locking material corresponding to the rotating direction while locking the rotation of the spindle as the said spindle continues its rotation by inertia caused on the spindle. Furthermore, the inertia (or impact) at the time of the locking is controlled and buffered by the resilient force of the rotation control structure controlling the position of the locking operation material and therefore, an impact or clunk arising from the sudden stop will not be produced, thus providing for a quiet stop.

Furthermore, when the inertia (or impact) caused by the lock as described above is bigger than the resilient force of the rotation controlling structure and when surpassing the controlled position, the rotation is still given effects of control and buffer by the resilient force of the rotation controlling structure so that the rotation by inertia of the spindle is reduced and controlled into the controlled position and thus quietly stopped.

As a form of embodiments, the rotation drive material may comprise the rotation body as the final step of the planetary gear for speed reduction for reducing the motor output and also, the spindle may be made in the shape of an axis. Alternatively, the fixing material of the locking structure may be formed in the shape of a ring.

As a form of embodiments, the above said locking structure may comprise a plurality of lock operation parts made of the locking material and the lock operating device, thus being formed.

Alternatively, the above said locking material comprises a pair of the rotating bodies corresponding to the right and locking rotations of the above said spindle (in the shape of a metal roller, a column and a sphere), the said rotating bodies being used as one set and the above said lock operating device may comprise a pair of the inclined surfaces with the said rotating bodies pressed against the fixing material according to the right and locking rotations of the above said spindle in order to correspond to the direction of the rotations with the wedge effects.

Alternatively, the above said locking material may comprise the brake shoe pressed against the fixing material, and the said lock operating device may comprise the operating cam for pressing and operating the said brake shoe against the fixing material with the right and locking rotations of the above said spindle.

As a form of embodiments, the above said rotation control structure is formed between the releasing material connected to the rotation drive material and the spindle material and the above releasing material comprises the controlling concave part in the determined controlling position, providing the above said controlling concave part with the resilient force from the spindle, facing the controlling concave part.

Alternatively, the above said rotation control structure is formed between the final end part of the rotation drive material and the spindle and in the said final end part there is provided the control concave part in the determined controlling position and it is possible to provide the said control concave part with the resilient force of the spindle, facing the said controlling concave part, thus controlling the position of the spindle.

As a form of embodiments, the above said rotation controlling structure may be controlled and placed in a location corresponding to the end part inside the free angle of the above said output electric structure or in a location corresponding to the place where the above said locking material is released or in a middle point inside the free angle.

Alternatively, the means for providing the above said rotation control structure with the resilient force is formed with the snap arm having the resilient force, extending from the outer circumference of the snap ring toward the direction of the circumference and also, a couple of snap arms extending in different directions are retained in one control concave part. According to this construction, the snap actions corresponding to the moving and locking of the rotation control structure may be carried out under the same one condition.

As a form of embodiments, the said locking material may be supported by the supporting material, which allows an elastic change toward the releasing side, right before the location where the said locking material functions, wherein this supporting material may be of materials like piano strings or synthetic resins, metal plates so that it is possible to obtain elasticity. According to this construction, the impact at the time of locking effects can be buffered on the side of the supporting material.

As a form of embodiments, the buffering material is provided to the fixing structure in order to fix the said fixing material of the locking structure for fixation. According to this construction, the impact at the time of the locking can be buffered even by the fixing measure.

Furthermore, the spindle lock system of the present invention can be provided to the output system of the electric instruments, in addition to the use with the device requiring the spindle.

There are many forms of embodiments regarding the present invention so that the scope of the present invention shall not be limited to the construction of the examples set forth below.

### BRIEF DESCRIPTION OF THE DRAWINGS

FIG. 1 Sectional view of the spindle lock system using the electric instrument to be operated by the hand.

FIG. 2 Magnified sectional view of the spindle lock system.

FIG. 3 Break-down plan of both each element of the structure of the spindle lock system and its side.

FIG. 4 Side view of the important parts of the spindle lock system.

FIG. 5 Side view, showing the connection of the spindle with the carrier.

FIG. 6 Break-down sectional view of the torque limiter.

FIG. 7 Side view, showing another example of the supporting ring.

FIG. 8 Side view, showing another more example of the supporting ring.

FIG. 9 Magnified sectional view showing another example of the rotation control structure of the spindle lock system (sectional view indicated with the line C-C′ in the FIG. 9).

FIG. 10 Break-down explanatory view of the rotation control structure in the FIG. 9.

FIG. 11 Sectional view indicated with the line A-A′ in the FIG. 9.

FIG. 12 Sectional view indicated with the line B-B′ in the FIG. 9.

FIG. 13 Side view showing another example of the rotation control structure of the spindle lock system.

FIG. 14 Explanatory view consisting of the sectional and side view of the locking system in the FIG. 13.

FIG. 15 Side view showing another example of the locking structure.

FIG. 16 Side view showing the operating condition of the FIG. 15.

### PREFERRED EMBODIMENT

A preferred embodiment of the present invention will be below explained using the figures.

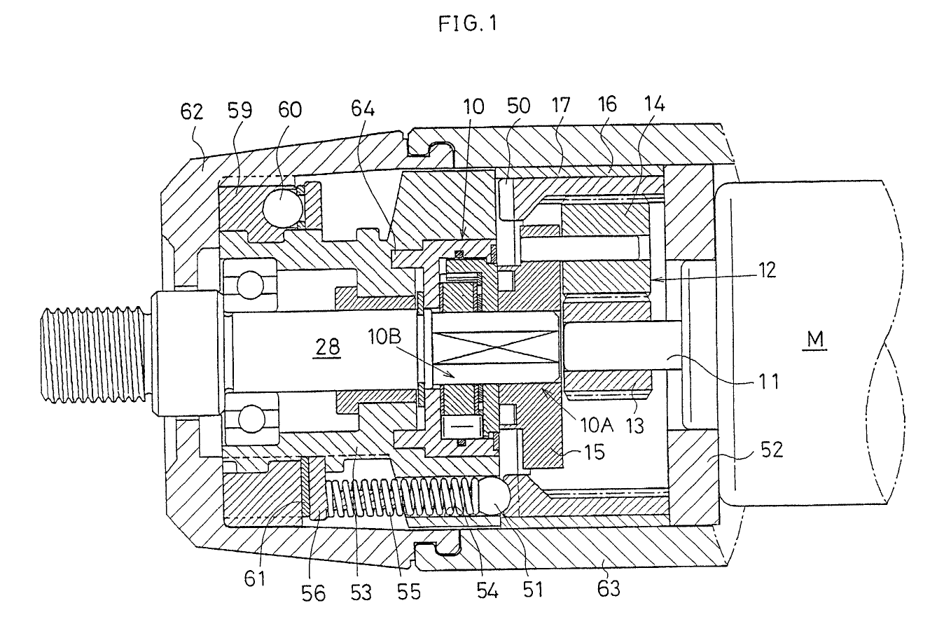

One example shows the spindle lock system to be used for the electric instrument moved by the hand and according to the FIG. 1, the above said spindle lock 10 is formed on the rear step of the outputting side of the motor M rotating in the right and locking directions.

The motor axis 11 of the above said motor M will be connected with the speed reduction structure 12 of a planetary gear, wherein the said speed reduction structure 12 of a planetary gear comprises the sun gear 13 and the planetary gear 14 for receiving the said sun gear 13 and the carrier 15 supporting the said planetary gear 14 and the internal gear 16 for receiving the planetary gear 14 and the fixing ring 17 retaining the said internal gear 16 in a way allowing for rotation and these are the conveying elements of the rotation conveyance system, having the speed reduction function as is well known and its speed reduction output is put out from the carrier 15.

On the other hand, the above said motor axis 11 is connected to the sun gear 13 of the speed reduction structure of the planet gear while conveying the rotation to the said gear, utilizing the mutual attaching structure like spline attachment.

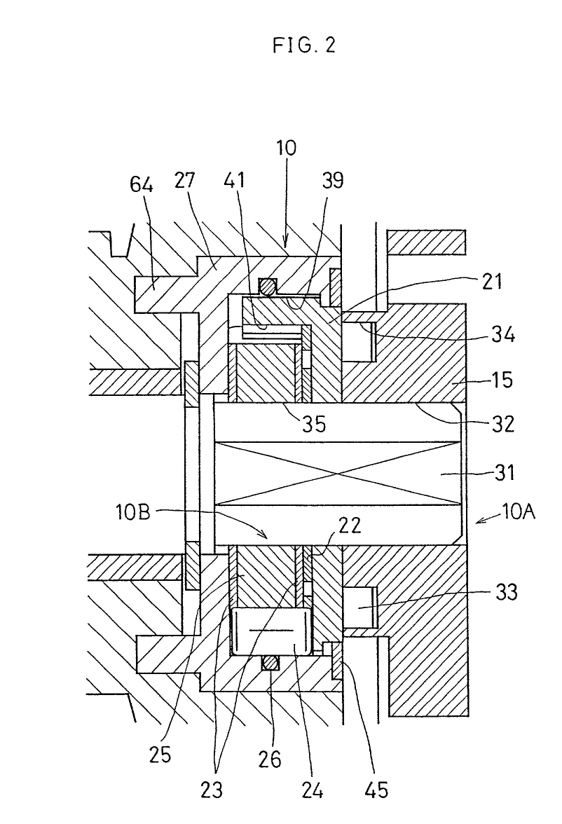

On the rear steps of the speed reduction structure 12 of the planetary gear as mentioned above, there is formed the spindle lock 10, which spindle lock 10 is provided with the output electric structure 10A for conveying the output force from the carrier 15 of the speed reduction gear of the planetary gear 12 to the spindle 28 and the locking structure 10B for locking each of the right and locking rotations from the spindle 28, as shown in the FIG. 2.

The above said output electric structure 10A comprises the carrier 15 and the spindle 28, wherein the spindle 28 has plane surfaces in parallel, using the two surfaces facing each other over that axis to form the axis-like connector 31, thus forming the hole-shaped connector 32 for attaching thereto, with a free angle α for 20 degrees on the axis part of the corresponding carrier 15 and furthermore, when these connecting parts 31, 32 are attached, the carrier 15 and the spindle 28 are to be connected with a free space for not conveying the rotating force for a free angle α.

The said spindle lock 10B comprises the release ring 21, snap ring 22, two supporting rings 23, 23, the wedge roller 24, the lock ring 25, the rubber ring 26, the fixing ring 27 and the spindle 28 and except for the wedge roller 24, each element is provided in the shape of a ring on the same axis.

On the back of the above said release ring 21, there are provided the pins 33, 33 on the corresponding places over the axle and wherein the pins 33, 33 are retained onto the connecting holes 34, 34 formed on the corresponding place of the said carrier 15, they will rotate in function of the carrier 15 with a free angle α.

Furthermore, on the center part of the said release ring 21 there is formed the hole connecting part identical to the hole connector 32 of the carrier 15, to which hole connecting part the connecting part in the form of an axis 31, of the spindle 28 is attached.

The above said lock ring 25 is connected with the axis connecting part 31 on the said spindle 28 around the axis without free movements to form the hole-shaped connecting part 35 to associate with the spindle 28 and also, on the outer circumference, there is formed a dividing protrusion 36 . . . on three places (with a distance of the angle of 120 degrees) equally separated from each other, and in both directions of the circumference of this dividing protrusion 36 there are formed the inclined surfaces of the wedge 37a . . . ,37b . . . being inclined toward the protrusion 36 in correspondence with the right and adverse rotation of the spindle 28.

The above-mentioned wedge roller 24 is formed in the shape of a roll, being provided in correspondence with the inclined surface of the wedge 37a, 37b of the above said lock ring 25 and therefore, the said wedge rollers 24 are used in three couples while two of them being used as one pair in correspondence with the right and locking rotations, wherein there are formed the above said dividing protrusion 36 and the inclined surfaces 37a, 37b according to the said three couples of the wedge rollers.

Also, the length of the wedge roller 24 is larger than the width (thickness) of the lock ring 25 and both ends of it are supported by the supporting rings 23, 23, which are in front and behind, as described above.

For this purpose, on each of the outer circumferences of the supporting rings 23, 23 there are formed the supporting protrusion 38 . . . in three places, equally separated from each other (with a distance of the angle of 120 degrees) and on both sides of the direction of the circumferences of the said supporting protrusion 38, a pair of the wedge rollers 24, 24 are supported as described above.

In addition, the center parts of the supporting rings 23, 23 are formed in the shape of a circle.

The said rubber ring 26, provided on the outer side of the wedge rollers 24 . . . supported as described above, gives rotation to each wedge roller 24 by the said friction.

The above said fixing ring 27 forms the inner circumference 39 capable of containing the said lock ring 25 and the supporting rings 23, 23 and to express differently, the inner circumference 39 and the outer circumference of the lock ring 25 (and/or the spindle 28) face each other in the direction of the radius with a given distance such that a pair of the wedge rollers 24, 24 . . . as described above can be placed between a pair of the inclined parts of the wedge 37a, 37b of the lock ring 25 and the above said inner circumference 39 and wherein the inclined parts 37a, 37b of the wedge are to be put in a place where the wedge rollers 24, 24 get stuck (pressed against) to be locked and the above-mentioned inclined parts of the wedge are set in such a distance that one of them can move from the place in which the said wedge rollers 24, 24 get stuck (that is a locking place or a place to be pressed against), to the releasing position.

To add, the supporting protrusion 38 of the above said supporting rings 23, 23 has such a width in the direction of the circumference that the wedge rollers 24, 24 can be supported in a releasing position.

For releasing the wedge rollers 24, 24 as described above, the releasing protrusion 41 . . . is connected on the side of the above-mentioned releasing ring 21.

In other words, on the side of the releasing ring 21 facing the wedge rollers 24, 24, there are installed the said releasing protrusions 41 . . . in three places equally separated from each other (with a distance of 120 degrees) in correspondence with three couples of the wedge rollers 24 . . .

The above said releasing protrusion 41 is designed to release the wedge rollers 24, 24 in correspondence with each end part in the direction of the radius by pressing them in the rotating direction and the width (or length) of the releasing protrusion 41 in the direction of the circumference is set in such a way that this function of releasing is to be done within a free angle a between the said releasing ring 21 and the spindle 28, especially at both ends of the said free angle α.

The above said releasing protrusions 41 . . . are provided with a controlling structure for controlling the said releasing protrusion 41 by resilient force when the said protrusion is in a position of releasing in function of the right and locking rotations.

Thus, on the side of the said releasing protrusion 41 facing the axle, there are formed the controlling concave parts 42a, 42b in correspondence with the right and adverse rotations. On the above said controlling concave parts 42a, 42b, the controlling convex part 43 of the said snap ring 22 is being retained with a resilient force being effective.

The above said controlling convex part 43 is formed at a free end part of the snap arms 44 . . . formed by extending in the same direction of the circumference from three equally separated positions on the circumference of the snap ring 22 while it is set in respect of the correlative place such that it will retain when each of the controlling concave parts 42a, 42b is placed in a releasing position and furthermore, its resilient force can be obtained from the elasticity of the material characteristic of the snap arm 44, wherein the same resilience is set to be smaller than the drive force on the side of the motor M.

Furthermore, the above said resilient force is set in a way allowing for moving the controlling protrusion 43 from one side of the controlling concave part 42a, 42b to another when the motor M is restarted.

Alternatively, the center part of the above said snap ring 22 forms the connecting part by being attached to the axis connecting part 31 of the spindle 28 so that it will rotate as one device.

In the figures, 45 indicates the lid ring and by attaching it to the fixing ring 27, each structural element is received in the fixing ring 27, thus making the spindle lock 10 function as an unit.

The above said speed reduction structure 12 of the planetary gear is provided with the torque limiter.

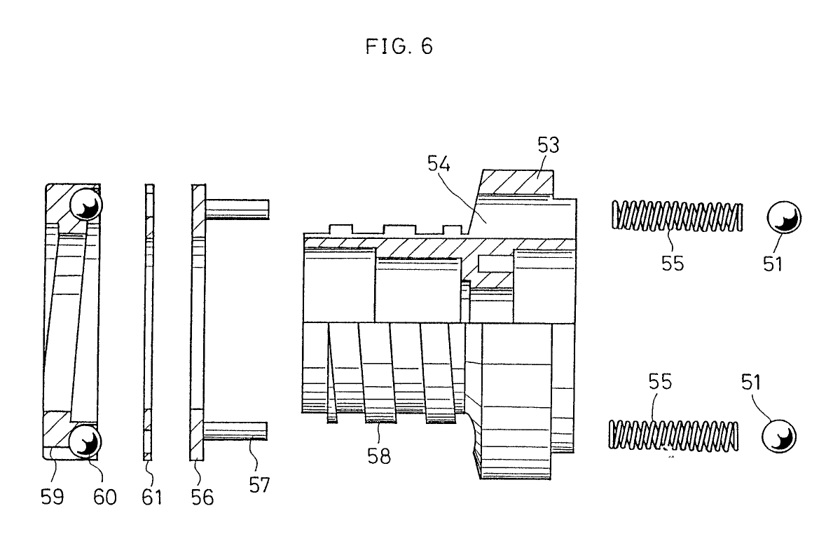

As shown in the FIGS. 1 and 6, according to the said speed reduction structure 12 of the planetary gear, the internal gear 16 is supported in a way allowing for free rotation in relation with the fixing ring 17, wherein the outside edge of the said internal gear 16 forms the concave an d convex surfaces 50, which are continuous in the direction of the circumference, the ball 51 being pressed against the same surface, and the internal gear 16 is pressed against the fixing plate 52 and by controlling its rotation, the torque limiter is provided.

A plurality of the above said balls 51 (six, for instance,) are formed close to the internal gear 16 on the circumference and on the position facing the outer edge of the said internal gear 16 there is formed the fixing material 53 adjacently and there is formed the containing hole 54 in a position facing the said ball 5 1, on the side facing the said internal gear 16 of the said fixing material 53, in order to contain the spring 55 for pressing the said ball 51, wherein the outer edge of the said spring 55 is kept by inserting the supporting pin 57 of the receiving material 56.

On the outer circumference of the alley side of the said fixing material 53 there is formed the screw 58 in the form of square screw, wherein the nut material 59 is screwed to the screw 58 and the said nut material 59 moves ahead and withdraws through the ball 60 and the ring 61 while the said receiving material 56 moves toward the axis and by adjusting the elasticity of the spring 55, it is also possible to adjust the torque of the torque limiter by the above said ball 51 and the concave and convex surface 50 of the internal gear 16.

Furthermore, the above said nut material 59 is connected to the operating cover 62 as in the spline attachment, in which rotation is conveyed while being able to move toward the axis and by rotating the operating cover 62, it is possible to rotate the nut material 59. Also, the fixing plate 52, fixing ring 17 and the fixing material 53 are connected as one in a convenient way in the outer case 63, while being fixed.

In addition, the fixing 27 of the said spindle lock 10 is retained onto the said fixing material 53 through the retaining part 64, thus fixing the rotation. Alternatively, the retaining part 64 may be formed in the shape of a pin to be inserted into the hole.

The function of the said spindle lock 10 is below explained.

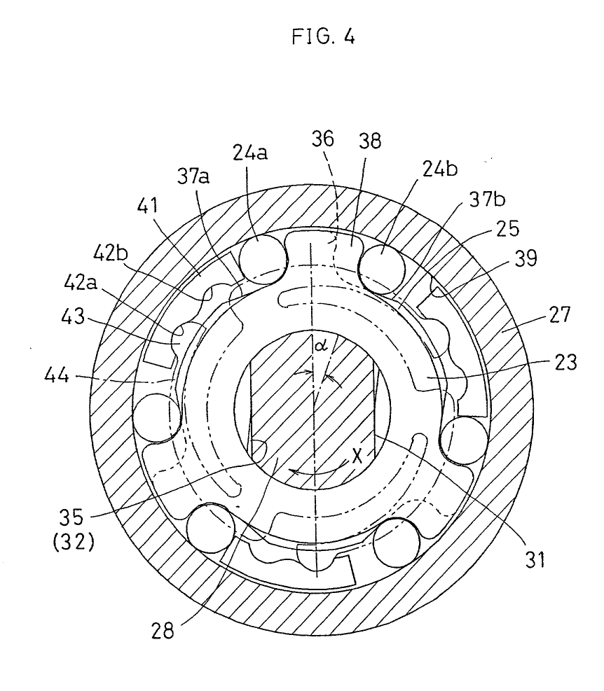

In the FIG. 4, for instance, when the carrier 15 and the releasing ring 21 of the speed reduction structure of the planetary gear is rotated in the direction of the rotation X by rotating right the motor M, the corresponding wedge roller 24a is pushed into the releasing position of the inclined surface 37a of the wedge of the lock ring 25 at the end of the rotation of the releasing protrusion 41. On the other hand, the other wedge roller 24b is kept in contact with the inner circumference 39 of the fixing ring 27 and by its contact resistance, the said wedge roller 24b is pushed into the releasing position of the inclined surface 37b of the wedge.

This releasing step is done within a free angle α in respect of the carrier 15 and the spindle 28 and afterwards, the hole-shaped connecting part 32 of the carrier 15 and the axis-like connecting part 31 of the spindle 28 are associated so that the driving force of the carrier 15 will be conveyed to the spindle 28 for its rotation.

At this time, the controlling convex part 43 of the snap arm 44 is retained to the controlling concave part 42a of the releasing protrusion 41, wherein the releasing ring 21 and the lock ring 25 will be controlled by the resilient force of the snap arm 44 in respect of the position, in a releasing position or at one end position of the free angle α.

Furthermore, when driving as described above, the releasing protrusion 41 of the releasing ring 21 operates with its force only necessary to push the wedge roller 24a into a releasing position and not large charge of force will be put on the said wedge roller 24a.

When driving of the motor M is stopped in the above condition, the carrier 15 and the spindle 28 will stop while being controlled by the resilient force of the snap arm 44 in respect of the position, wherein the controlling convex part 43 of the snap arm 44 is retained to the said controlling concave part 42a of the releasing protrusion 41.

At this time, when the tool whose inertia is less than the resilient force of the snap arm 44, is attached to the spindle 28, it can stop in the above said position of control.

Furthermore, when the inertia of the above-mentioned tool is larger than the resilient force of the snap arm 44, the inertia becomes larger than the resilient force of the snap arm 44 so that the controlling convex part 43 is retained to the controlling concave part 42b, however, when this controlling protrusion 43 is removed from the said controlling concave part 42a, its resistance will have the controlling and buffering function to operate on the inertia so that the said inertia will be reduced at an early stage to retain to the next controlling concave part 42b and the rotation by inertia of the spindle 28 will stop.

Thus, the rotation by inertia of the tool is controlled by the retention of the controlling concave part 42a, 42b with the controlling convex part 43 of the snap arm 44 so that there is no impact to the material or impact sound when the rotation has stopped, while avoiding the chattering phenomenon, allowing for being stopped while there is no sound heard.

Therefore, the rotation control device comprises the controlling concave part 42a, 42b, controlling convex part 43 and the snap arm 44.

When the said motor M, having been stopped, is rotated right and adversely from the side of the spindle 28, the said spindle 28 will be locked because of the function of the locking structure 10B and its rotation will be stopped.

In other words, when the spindle 28 is rotated right and adversely, the wedge roller 24a or 24b in a corresponding direction will be close to the inner circumference 39 of the fixing ring 27 and with its contact resistance, the said wedge roller gets into the said inner circumference 39 and the inclined surfaces 37a and 37b of the wedge of the lock ring 25 (while being pressed against) so that the rotation in each direction will be locked.

When locking as described above, an efficient operation can be obtained in attaching the chuck to the spindle 28 and also in case of rotating the electric instrument as the motor M is still.

When restarting the motor M, the part of the releasing protrusion 41 in the rotating direction moves one wedge roller 24a in to a releasing position, wherein the other wedge roller 24b touches the inner circumference 39 of the fixing ring 27 to be pushed into a releasing position, thus allowing for the drive of the spindle 28. Alternatively, when the spindle 28 is driven and the wedge rollers 24 . . . revolve, the said wedge rollers 24 . . . are kept in contact with the rubber ring 26 and with this contact resistance, the wedge roller 24 . . . rotate while revolving, and by the operation of this rotating step, the axis of the wedge rollers 24 . . . is kept in parallel with the center of the spindle 28, thus preventing inclination.

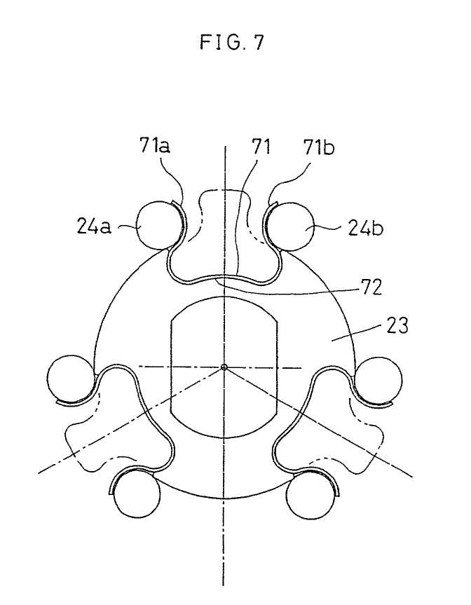

The FIG. 7 shows another example of the said supporting ring 23 of the spindle lock 10. In the first example, the wedge rollers 24a, 24b are supported in a releasing position by the supporting protrusion 38 of the supporting ring 23, however in this example, the same wedge rollers are supported by the concave parts 71a, 71b of the elastic material 71, being formed of the piano string and elastic.

The elastic material 71 as described above, is kept and attached to the concave part 72, being formed in correspondence with the supporting ring, in its warping base. Furthermore, the center part of the supporting ring 23 is formed in correspondence with the hole shaped (connecting part of the spindle 28. However, the same supporting ring may have a round shape.

The said wedge rollers 24a, 24b are set to be supported in a releasing position of the said wedge rollers 24a, 24b as described in the first example, and however, the said position corresponds to the place right before that of the operation of each wedge of the wedge rollers 24a, 24b. Furthermore, they are supported by elasticity so that they may allow for an elastic change toward the releasing side.

When thus supported by elasticity and the wedge rollers 24a, 24b are being locked, the releasing protrusion 41 touches to release in order to give an elastic change upon collision, thus attenuating the shock.

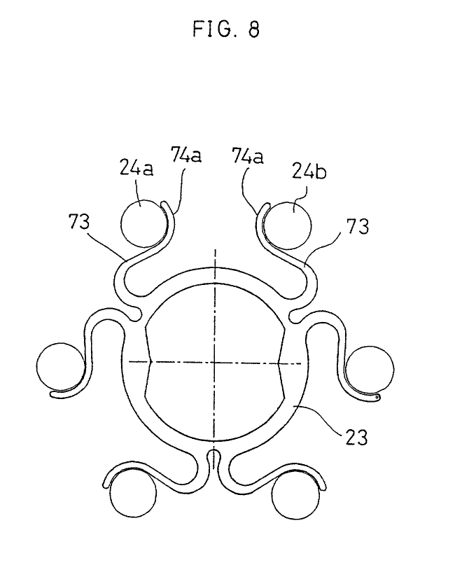

The FIG. 8 shows another example of the supporting ring 23 of the said rotation output device 10. According to the above described example 7, there was kept and attached to the supporting ring 23 the elastic material 71, which was elastic being formed of the piano string material and however, according to this example, the wedge rollers 24a, 24b are supported by the concave parts 74a, 74b formed on the end part of the arm 73, so formed as to be elastic against the supporting ring 23. It is noted that this supporting ring 23 is formed of the metal plate or synthetic resin and its center part is made to correspond to the hole-shaped connecting part of the carrier 15. However, it may as well be in the shape of a disk.

Even when thus constructed, the same effects and functions can be obtained as the supporting ring 23 shown in the FIG. 7.

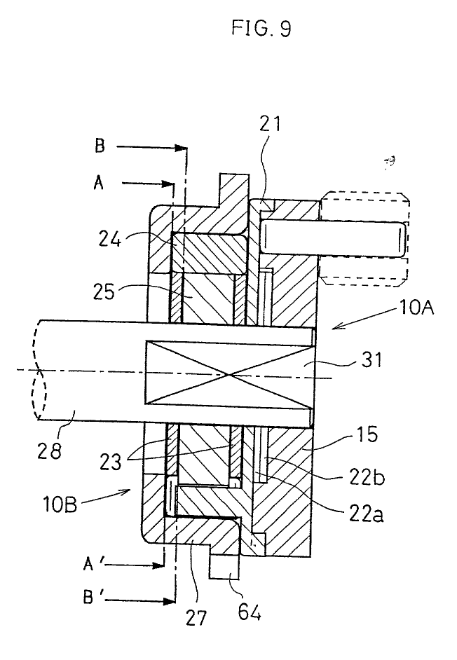

The FIGS. 9 to 12 show other examples of the rotation control device regarding the spindle lock 10. Thus, regarding the construction elements having the same function as the first example shown in the FIGS. 1 to 5, the same signs are put and its detailed explanation will be omitted.

The rotation control device in this example comprises the control concave part 42a, 42b and the control convex part 43 of the snap arm 44 of the snap ring 22 in the same manner as in the said first example already described, wherein the end part of the carrier 15 of the planetary gear structure for speed reduction and the spindle 28 corresponding to the said location are formed on the said rotation control device and furthermore, the snap ring 22 uses two of the snap rings 22a, 22b, wherein the snap arm 44 is turned around, thus forming the snap ring 22.

In other words, the outer end part of the carrier 15 comprises the containing concave part 82 having the inner circumference 81 capable of containing two of the snap rings 22a,22b and in three locations which are placed equidistantly in the inner circumference of the said containing concave 82, the releasing device works by means of the wedge roller 24a, 24b and the wedge-like inclined surfaces 27a, 27b of the locking ring, thus forming the control concave parts 42a, 42b in correspondence with the right and locking rotations.

The snap rings 22a, 22b to be contained in the above said containing concave part 82 forms two of snap rings 22, namely, 22a, 22b of one kind forming the control convex part 43 at a free end of the snap arm 44 provided with the resilient force, extending in the direction of the circumference from the outer surface of a snap ring 22, each of the snap arms 44a, 44b extending in different directions with the control convex parts 43a, 43b put upon them, wherein the control convex parts 43a, 43b thus put upon the said snap arms are to be retained and incorporated to the control concave parts 42a or 42b.

Thus, when the snap arms 44a, 44b with the snap rings 22a, 22b put upon them are made to function from different directions, snap actions in correspondence with the right and locking rotation of the rotation control device will have the same condition.

For instance, according to the first example (see the FIG. 4), with the use of one snap ring 22, the controlling protrusion 43 of the said snap arm 44 will receive the charge from the direction of the free side of the snap arm 44 to be subject to the said charge strongly, however, when there is a charge from the direction of the root side of the snap arm 44, it will have a smooth action, thus giving different snap actions according to the right and locking rotations.

However, according to this example, as described above, the snap arms 44a, 44b are overlapped in different directions, each action corresponding to the right and locking rotations will have an effect on one control concave part 42, therefore, the snap actions corresponding to the right and locking rotations will have the same condition. It is needless to point out that the snap ring 22 as in the said first example may comprise two different snap rings 22a, 22b.

The guard-like part 83 is formed on the outer circumference facing the carrier 15 of the said releasing ring 21 and the retaining convex parts 84 . . . are formed in three locations where the said guard-like parts are equidistantly placed and accordingly the step 85 is formed on the outer circumference of the carrier 15, wherein the retaining concave parts 86 . . . are formed in the locations corresponding to the said retaining convex parts 84 . . . and wherein the guard-like part 83 is attached to the step 85 while these retaining convex parts 84 . . . and the retaining concave parts 86 . . . are being retained so that the releasing ring 21 and the carrier 15 can be mounted as one device while being prevented from rotating. Naturally, for this installment, two of the snap rings 22a, 22b can be incorporated as described above, into the containing concave part 82.

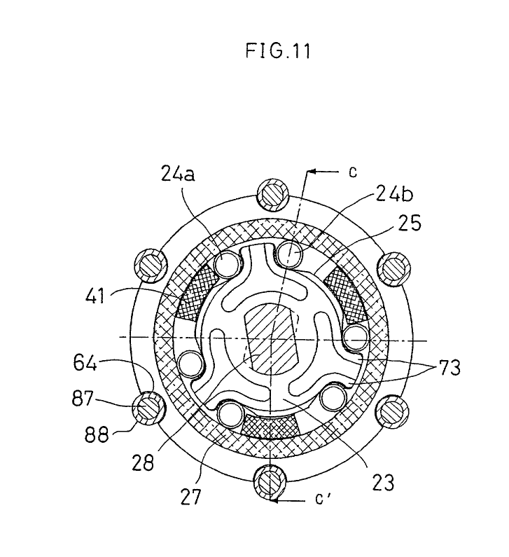

In the FIG. 11, the supporting ring 23 supporting the wedge rollers 24a, 24b is formed to adopt the supporting ring 23 provided with the elastic arms 73, 73 as shown in the FIG. 8.

Alternatively, the concave retaining parts 64 . . . are formed in a plurality of places equidistantly located on the outer circumference of the fixing ring 27 and the said concave retaining parts 64 . . . are to be retained to the fixing material 53 as shown in the FIG. 1 while being prevented from rotating and according to the present example, the pins 87 . . . are installed on the side of the fixing material 53 and to which pins the said concave retaining parts 64 . . . are to be retained through the rubber material and other buffering materials 88 . . . having buffering functions.

To describe differently, when the wedge rollers 24a, 24b are locked, their impact will be conveyed to the fixing material 27, thus turning into a charge to rotate the said fixing material and this impact charge can be buffered by the said buffering material 88.

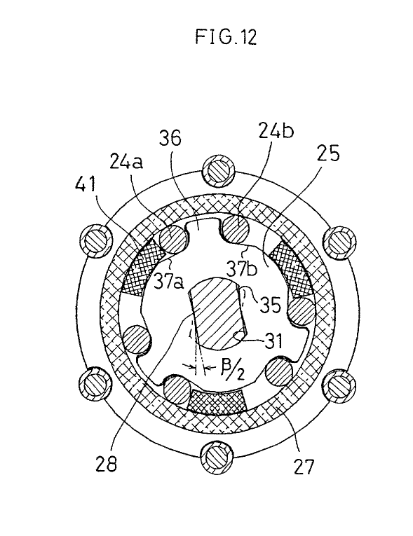

According to the FIG. 12, the hole-shaped connecting part 35 of the locking ring 25 and the axle-like connecting part 31 of the spindle 28 are attached in such a way that the hole-shaped connecting part 35 of the locking ring 25 forms a free angle β against the axis-like connecting part 31 of the spindle 28, wherein this free angle β is set to be smaller (for example, the angle of 10 degrees) than the free angle α (for example, the angle of 20 degrees), in respect of the hole-shaped connecting part 32 of the carrier 15 and the axis-like connecting part 31 of the spindle 28. The free angle β is set to allow the spindle 28 and the axis-like connecting part 31 to be connected easily.

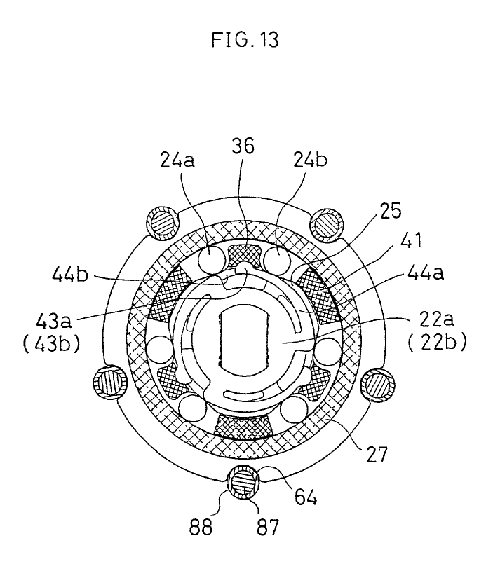

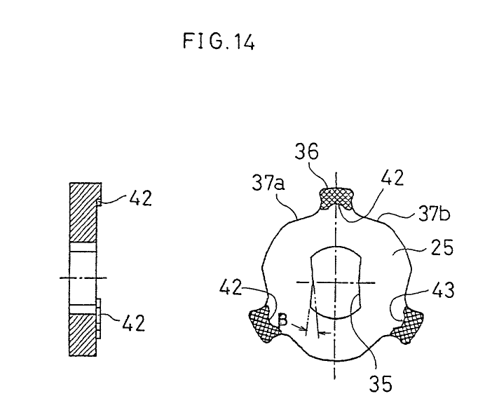

The FIGS. 13, 14 show other examples of the rotation control structure in the spindle lock 10.

Thus, the structure elements having the same function as the first example shown in the FIGS. 1 to 5 and other examples shown in the FIGS. 9 to 12 will have the same sings put, while omitting more detailed explanations.

The rotation control structure in this example comprises the control concave part 42 and the control convex part 43 of the snap arm 44 of the snap ring 22 in the same manner as in the above first example and other examples, wherein the present rotation control structure is constructed in the end part of the locking ring 25 and the part facing the spindle 28 in correspondence with the said location and wherein the control concave part 42 is formed in one place corresponding to the right and locking rotations.

To add, the snap ring 22 uses two of the snap rings 22a, 22b, wherein the snap arms 44a, 44b are turned around, just as in the above other examples shown in the FIGS. 9 to 12. Alternatively, for the attachment of the hole-shaped connecting part 35 of the locking part 25 with the axis-like connecting part 31 of the spindle 28 (see the FIGS. 11 and 12), there is formed a free angle β in respect of the hole-shaped connecting part 35 of the locking ring 25, under the same condition as in the above other examples.

The dividing protrusion 36 of the said locking ring 25 is set in the middle place of the said locking ring 25, within which to operate the wedge rollers 24a, 24b in correspondence with the right and adverse rotations so that, utilizing this middle location, on the end part of the said dividing protrusion 36 there is formed a control concave part 42, which one part can respond to the right and adverse rotations, wherein the control convex parts 43a, 43b of the snap rings 22a, 22b are retained to the said control concave part 42.

In other words, the locking ring 25 is controlled in respect of the place from the spindle 28 by means of the resilient force of the snap arms 44a, 44b of the snap rings 22a, 22b.

According to this example, when the drive of the motor M is stopped and the spindle 28 continues its rotation by inertia, the locking ring 25 operates the wedge roller 24a or 24b corresponding to the direction of the rotation in order to lock the rotation of the spindle 28. Furthermore, the inertia (or impact) at the time of this locking will be buffered by the resilient force of the snap arms 44a, 44b of the snap rings 22a, 22b controlling the locking ring 25 in terms of the place so that there is no impact or clunk caused by a sudden stop, thus allowing for a quiet stop.

Furthermore, even though the inertia (or impact) caused by the above locking is larger than the resilient force of the snap arms 44a, 44b and the control convex part 43 springs out of the control concave part 42, the rotating force by the inertia is still subject to the control of the resilient force of the snap arms 44a, 44b and its buffering effects so that the rotation by inertia of the spindle 28 can be reduced in respect of the speed at an early stage and can be stopped quietly.

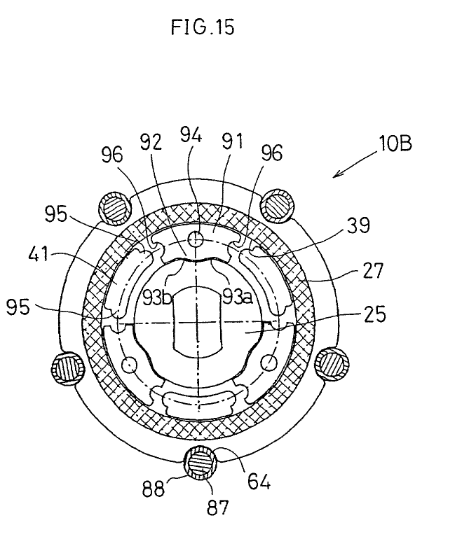

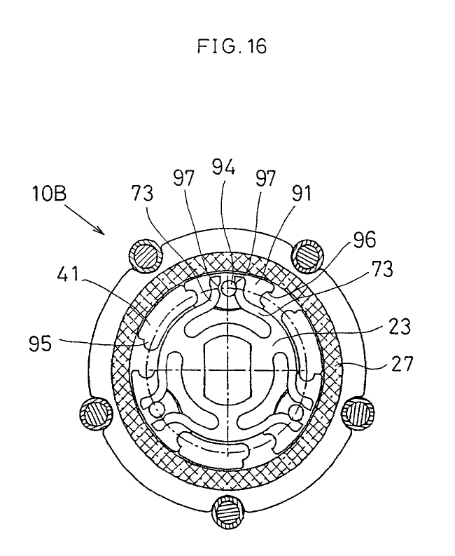

The FIGS. 15 and 16 show other examples of the locking structure 10b in the spindle lock 10, omitting the structure of the rotation control device. Regarding the structure elements having the same functions as the first example shown in the FIGS. 1 to 5 and other examples already described, the same signs are put and its detailed explanation will be omitted.

In this example, between the inner circumference 39 of the fixing ring 27 and the outer circumference of the locking ring 25, three brake shoes 91 . . . are provided, which are equidistantly placed, having the same structure. This brake shoe 91 is formed of the material suitable for control effects or metal and when the material is metal, on each of the outer circumference and the inner circumference 39 of the fixing ring 27, there can be provided the concave and convex parts, thus allowing for a larger friction resistance.

In the inner center part of each brake shoe 91 . . . , there is formed a mountain-like subsequent cam 92 working, which is operated from both directions of the right rotation and the locking rotation.

Furthermore, on the outer circumference of the locking ring 25, according to the movements of the subsequent cam 92 of the above said brake shoes 91 . . . , there are formed the surface of the cams 93a, 93b for operating from the said right rotation side and locking rotation side.

Also, in the hole-shaped connecting part 35 of the center part of the locking ring 25 and for the attachment with the axis-like connecting part 31 of the output axle 28, there is formed a free angle β in the hole-shaped connecting part 35 of the locking ring 25.

Because of the right and locking rotation of the above said locking ring 25, the cam surfaces 93a, 93b boost up the subsequent cam 92 of the brake shoe 91 while pressing the outer circumference of the said brake shoe 91 against the inner circumference 39 of the fixing ring 27, the right and adverse rotation from the spindle 28 can be locked. It is needless to say that this locking and releasing can be done within a free angle α of the spindle 28 with the carrier 15. Between each of the brake shoes 91 . . . there is provided the releasing protrusion 41 and when driven from the carrier 15, the said releasing protrusions 41 . . . come close to the outer surface of each of the brake shoes 91 . . . , thus releasing these close attachments.

On the end part of the said releasing protrusion 41 and the facing end of the brake shoe 91, there is formed the retaining convex part 95 and the retaining concave part 96, which are convex and concave and when the retaining convex part 95 and the retaining concave part 96 are retained, the outer circumference of the brake shoe 91 is provided in such a way that it is placed a little bit far inside in respect of the inner circumference 39 of the fixing ring 27.

In the center of the side of the said brake shoe 91 there is provided a pin 94 in the shape of an axis and in front of the brake shoe 91, there is provided the supporting ring 23 for rotating with the spindle 28 (which is not shown in the figure), as one device and by means of a pair of the arms 73, 73, facing each other, of the said supporting ring 23, the said pin 94 is controlled in respect of the place.

In other words, in a place facing the said arms 73, 73 there is provided the retaining concave parts 97, 97 for retaining the above said pin 94 and when these retaining concave parts 97, 97 and the pin 94 are retained, the outer circumference of the brake shoe 91 is provided in such a way that it is placed a little bit far inside in respect of the inner circumference 39 of the fixing ring 27.

When the above said brake shoe 91 is kept pressed (being locked) against the fixing ring 27 even with the releasing step of the cam surfaces 93a, 93b of the locking ring 25, the retaining convex part 95 of the end part of the releasing protrusion 41 will be retained to the retaining concave part 96 of the brake shoe 91, thus releasing the brake shoe 91.

At the same time, in the above retaining action, the outer circumference of the brake shoe 91 is separated from the inner circumference 39 of the fixing ring 27 and the pin 94 of the said brake shoe 91 and the retaining concave part 97 of the arm 73 of the supporting ring 23 for retention will be retained so that the outer circumference of the center part of the brake shoe 91 will be separated from the inner circumference 39 of the fixing ring 27, so that the brake shoe 91 will be kept supported in two places of one end part and the center part while the outer part is kept untouched, thus releasing the locking. In this way, the drive from the motor M will be allowed. Therefore, the scraping sound of the brake shoe 91 will be avoided when driving.

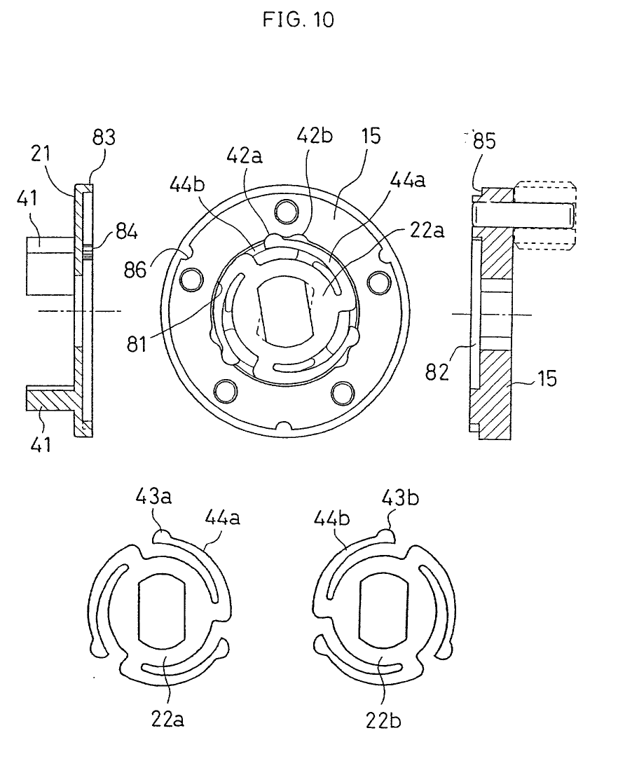

Like this, the locking device 10 B can be constructed. Alternatively, the rotation control device to be used for this example of the locking device 10 B can be utilized with the construction of the FIGS. 9 and 10 and the FIGS. 13 and 14.

Function and Effect of the Invention:

According to the present invention, by means of the resilient force of the rotation control device, the rotation drive material, the spindle material and the lock operation material of the locking device through the spindle material will be controlled into the determined place with the said resilient force.

With this, when the tool whose rotation charge is high, such as the hole saw or other disc rotation body, is attached to the spindle material through the chuck, stopping the motor, for example, and stopping the drive of the rotation drive material and stopping the rotation of the spindle material, even though the spindle material would continue its rotation by inertia, the resilient force of the rotation control device would have the function of control an (buffer upon the rotating force by the inertia while controlling the said spindle material into the controlled position so that there is no impact or clunk caused by the sudden stop, providing for a quiet and silent stop.

Furthermore, when the inertia of the above said spindle material is larger than the resilient force of the rotation control device and even when the said spindle material goes past the controlled position once controlled, the rotating force still has the function of the control and buffer of the resilient force of the rotation control device so that the rotating force by inertia will be controlled into a controlled position while the said rotating force is being reduced, thus providing a silent and quiet stop without chattering arising.

Therefore, there is no impact or clunk arising from the stop of the rotation drive material, thus providing for a quiet stop and on the other hand, a damage or loss of the inner structure element caused by the above said impact can be prevented.

Furthermore, the rotating of the output electric structure by means of the rotation drive material and the spindle material will have no charge upon the locking device so that the locking material of the said locking device will not be fixed or pressed upon the releasing side material, thus providing for a constant and smooth locking function of the locking material.

FIG. 1 10 . . . Spindle lock system

15 . . . Carrier

28 . . . Spindle

10A . . . Output electric structure

10B . . . Locking structure

FIG. 2 10 . . . Spindle lock system

15 . . . Carrier

21 . . . Releasing ring

23 . . . Supporting ring

24 . . . Wedge roller

27 . . . Fixing ring

31 . . . Axis-shaped connecting part

25 . . . Locking ring

32,35 . . . Hole-shaped connecting part

39 . . . Inner circumference

41 . . . Releasing Protrusion

10A . . . Output electric structure

10B . . . Locking structure

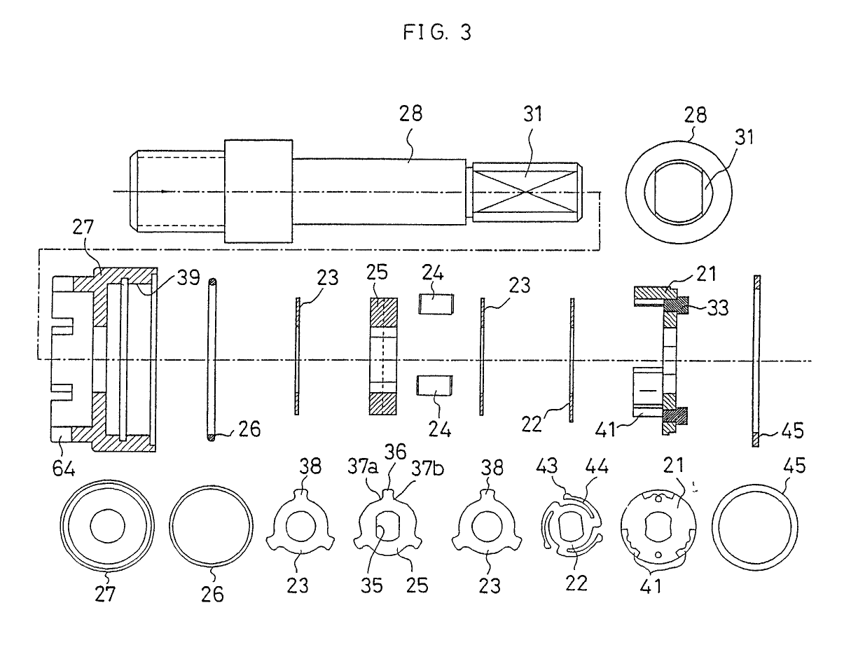

FIG. 3 21 . . . Releasing ring

22 . . . Snap ring

23 . . . Supporting ring

24 . . . Wedge roller

25 . . . Locking ring

27 . . . Fixing ring

31 . . . Axis-shaped connecting part

28 . . . Spindle

35 . . . Hole-shaped connecting part

37a, 37b . . . Inclined surface of the wedge

39 . . . Inner circumference

41 . . . Releasing protrusion

43 . . . Controlling convex part

44 . . . Arm

FIG. 4 23 . . . Supporting ring

25 . . . Lock ring

27 . . . Fixing ring

31 . . . Axis-shaped connecting part

28 . . . Output axis

32, 35 . . . Hole-shaped connecting part

37a, 37b . . . Inclined surface of the wedge

39 . . . Inner circumference

41 . . . Releasing protrusion

42a, 42b . . . Controlling concave part

43 . . . Controlling convex part

44 . . . Arm

α . . . Free angle

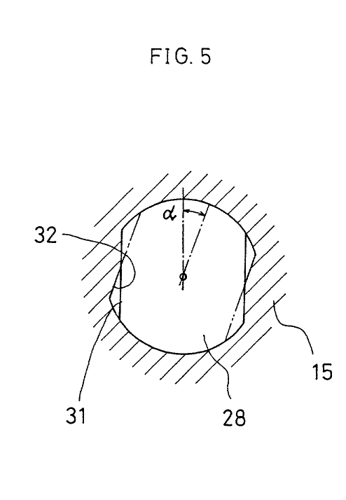

FIG. 5 15 . . . Carrier

28 . . . Spindle

31 . . . Axis-shaped connecting part

32 . . . Hole-shaped connecting part

α . . . Free angle

FIG. 6

FIG. 7 23 . . . Supporting ring

FIG. 8 23 . . . Supporting ring

FIG. 9 10A . . . Output electric structure

10B . . . Locking structure

15 . . . Carrier

21 . . . Releasing ring

22a, 22b . . . Snap ring

24 . . . Wedge roller

25 . . . Lock ring

27 . . . Fixing ring

28 . . . Spindle

FIG. 10 15 . . . Carrier

21 . . . Releasing ring

22a,22b . . . . Snap ring

41 . . . Releasing Protrusion

42a,42b . . . Control Concave part

43a,43b . . . Control Concave part

44a,44b . . . Snap arm

FIG. 11 24a,24b . .Wedge roller

25 . . . Locking ring

27 . . . Fixing ring

41 . . . Releasing Protrusion

FIG. 12 24a,24b . . . . Wedge roller

25 . . . Locking ring

27 . . . Fixing ring

28 . . . Spindle

FIG. 13 22a,22b . . . Snap ring

24a,24b . . . Wedge roller

25 . . . Locking ring

27 . . . Fixing ring

41 . . . Releasing protrusion

43a, 43b . . . Control convex part

44a,44b . . . Snap arm

FIG. 14 25 . . . Locking ring

42 . . . Control concave part

FIG. 15 10B . . . Locking structure

25 . . . Locking ring

27 . . . Fixing ring

41 . . . Releasing protrusion

91 . . . Brake shoe

92 . . . Subsequent Cam

93a,93b . . . Surface of the Cam

FIG. 16 10B . . . Locking structure

23 . . . Supporting ring

27 . . . Fixing ring

41 . . . Releasing protrusion

91 . . . Brake shoe

1. The spindle lock system, in which there is provided an outputting electric structure connecting the rotation drive material for outputting the rotation drive force and the spindle material for outputting the rotation force driven by the said rotation drive material so that there is formed a free angle preventing the rotation force for a determined angle in the mutual rotation directions on the same axis in order to convey the rotation force, being provided with the said spindle material and the fixing material which fixes the rotation by being placed on the outer part of the said materials with a determined distance on the radius, wherein, between the said spindle material and the fixing material, there is provided a locking material for locking the right and locking rotation of the said spindle material and wherein the said locking material is pressed onto the fixing material, together with the lock operation material for pressing and attaching the said locking material onto the fixing material by the right and locking rotation of the said spindle material and with the locking structure formed and provided with the releasing material capable of releasing the locking device of the said locking material having been pressed by the right and locking rotation of the said rotation drive material, containing the rotation controlling structure for controlling both of the said materials with a resilient force in a controlling position, between the side of the said rotation drive material and the spindle material.

2. The spindle lock system, provided with the said output electric structure and the locking structure, wherein the locking operation material of the said locking structure is attached onto the said spindle material with a subsequent free angle smaller than the free angle of the said output electric structure and between the said locking operation material and the said spindle material there is provided a rotation controlling structure for controlling the said locking operation material in function of the right and locking rotations in such a middle position as to be able to operate the said locking material, by means of the resilient force, comprising the output electric device in which the rotation drive material for outputting the rotation drive force and the rotation spindle material for outputting the rotating force, driven by the said rotation drive material are connected so that the rotating force can be conveyed in the direction of both rotations on the said axis, forming a free angle where the rotation force for the determined angle will not be conveyed, together with the locking device, wherein the said spindle material and the fixing material, fixing the rotation by being placed on the outer part of the said material, are installed facing each other over a determined distance on the radius and between these spindle material and the fixing material, there are provided the locking material for locking the right and adverse rotation by the said spindle material while the said locking material is being pressed against the fixing material and also with the lock operation material for operating and pressing the said lock material on the fixing material by means of the right and locking rotation concerning the said rotation material and a locking device being formed, wherein there is provided a releasing material capable of releasing the said lock material being pressed against, by means of the right and locking rotation of the said rotation drive material.

3. The spindle lock system according to the claims 1 and 2, wherein the above said locking material comprises a pair of the rotating bodies corresponding to the right and locking rotations of the above said spindle material, the said rotating bodies being used as one set and the above said locking operation material may comprise a pair of the inclined surfaces of the wedge with the said rotating bodies pressed against the fixing material according to the right and locking rotations in function of the right and locking rotations of the above said spindle material in order to correspond to the direction of the rotations with the wedge effects.

4. The spindle lock system according to the claims 1 and 2, wherein the above said locking material may comprise the brake shoe pressed against the fixing material, and the said locking operation material may comprise the material provided with the operating cam side for pressing and operating the said brake shoe against the fixing material with the right and locking rotations of the above said spindle material side.

5. The spindle lock system according to the claim 1, wherein the above said rotation control structure is formed between the releasing material connected with the rotation drive material and the spindle material and the above releasing material comprises the controlling concave part in the determined controlling position, providing the above said controlling concave part with the resilient force of the spindle material facing the controlling concave part.

6. The spindle lock system according to the claim 1, wherein the above said rotation control structure is formed between the final end part of the rotation drive material and the spindle lock material and in the said final end part there is provided the control concave part in the determined controlling position and it is possible to provide the said control concave part with the resilient force of the spindle lock material facing the said controlling concave part, thus controlling the position.

7. The spindle lock system according to the claims 1, 5 or 6, wherein the above said rotation controlling structure may be controlled and placed in a location corresponding to the end part inside the free angle of the above said output electric structure or in a location corresponding to the place where the above said locking material is released or in a middle point inside the free angle.

8.The spindle lock system according to the claims 1, 2, 5 or 6, wherein the means for providing the above said rotation control structure with the resilient force is formed with the snap arm having the resilient force, extending from the outer circumference of the snap ring toward the direction of the circumference and also, a couple of snap arms extending in different directions are retained in one control concave part.

9. The spindle lock system according to the claims 1 or 2, wherein the said locking material may be supported by the supporting material, which allows an elastic change toward the releasing side, right before the location where the said locking material functions.

10. The spindle lock system according to one of the claims 1 to 9, wherein the buffering material is provided to the fixing structure in order to fix the said fixing material of the locking structure for fixation. According to this construction, the impact at the time of the locking can be buffered even by the fixing measure.

11. The electric instrument, wherein the spindle lock system according to one of the claims 1 to 10 can be provided to the output system.
